(19) United States
(12) Patent Application Publication
(10) Pub. No.: US 2023/0339562 A1
(43) Pub. Date: Oct. 26, 2023

(54) A MONOWHEEL SYSTEM

(71) Applicant: WATT CAR INDUSTRIES LTD., Tel Aviv (IL)

(72) Inventors: Amos CAHAN, Netaim (IL); Ran QUANTZ, Tel Aviv (IL); Avidor REGEV, Tel Aviv (IL)

(21) Appl. No.: 17/789,281

(22) PCT Filed: Dec. 22, 2020
(86) PCT No.: PCT/IL2020/051321

§ 371 Date: Jun. 27, 2022

(30) Foreign Application Priority Data
Dec. 25, 2019 (IL) 271708

(51) Int. Cl. B62K 1/00; B62J 1/10; B62J 27/00; B60B 21/06; B60B 1/04

(52) U.S. Cl. CPC B62K 1/00; B60B 1/04; B60B 21/06; B62J 1/10; B62J 27/00; B60B 2900/311; B60B 2900/3312

(57) ABSTRACT

Coordinated movement transformable monowheel system formation generating electromagnetic induction power, including an automatic transformable configuration in case of an actual or impending accident in order to minimize impact to a user, or in order to enhance the comfort level of a user.

### FIELD OF THE INVENTION

The present invention refers to the field of monowheel systems, and, more particularly, to the field of safety devices and energy conservation techniques for use in monowheel systems.

### BACKGROUND OF THE INVENTION

Modern designs of monowheels offer improvements in areas that used to be considered as traditionally weak points of monowheels design (such as disclosed in publication PCT/IL2019/050954). For example, the speed, stability, convenience and utility of motorized monowheels are now further enhanced by current technological developments. Nonetheless, a traditional monowheel design is considered to be associated with challenges. For example, since monowheels are lighter than automobiles (such as passenger cars, trucks, etc.) they are considered to be less protective of a user(s) therein. Since monowheels tend to be lighter than automobiles, their structure integrity and chassis are vulnerable in case of a collision, and may be distorted in case of a strong impact resulting in a serious injury to a user seated therein.

Another concern may be the relatively small dimensions of a monowheel which limit the inner space provided to a user therein, and also restrict the size (and capacity thereof) of an energy reservoir used to propel a standard monowheel vehicle.

Moreover, a typical monowheel’s design and structure would pose a challenge to the comfort and safety levels of passengers which are not shielded as they may be in orthodox automobiles. On the other hand, improvements in monowheels’ capabilities may contribute to their prevalence in various modes of modern transportation and various traffic solutions.

Such ubiquity may require fundamental changes to monowheels’ design and may require, for example, flexible and modified seating solutions that may provide for increased comfort and/or safety level.

There is therefore a need for safety and utility improvements in monowheel design, which cannot derogate from the monowheels’ benefits, such as lesser size, weight and greater energy efficiency.

### SUMMARY OF THE INVENTION

The present invention provides a monowheel system that has an improved ability to protect its passenger and further provide enhanced comfort and safety level.

Among suggested enhanced safety and comfort solutions, a transformable seat for use in a monowheel that is configured to be automatically transformed in case of an actual or impending accident in order to minimize impact to a user, or in order to enhance the comfort level of a user.

Said system may address the reduced protection a typical monowheel provides due to its lesser size and weight, by suggesting an ejection seat configured to propel the user from within the monowheel or within it in case of a severe impact.

Said system may include a solution for the restricted energy reservoirs of a single monowheel vehicle by suggesting coupling multiple monowheels to form a formation. Said formation can enable the operation of some of the monowheel in an autonomous mode.

Said system may further include using the coordinated movement of the monowheel formation in order to generate power using an electro-magnetic induction, thus, providing an energy-efficient transportation platform.

The following embodiments and aspects thereof are described and illustrated in conjunction with systems, devices and methods which are meant to be exemplary and illustrative, not limiting in scope. In various embodiments, one or more of the above-described problems have been reduced or eliminated, while other embodiments are directed to other advantages or improvements.

According to one aspect, there is provided a transformable seat system for use in a monowheel comprising at least one transformable seat which comprises at least two adjustable parts and configured to be mounted within the inner cavity of the monowheel and a controller.

According to some embodiments, the controller is configured to control the configuration and relative position of the adjustable parts forming the transformable seat and the bearings of the transformable seat.

According to some embodiments, the controller is a computing platform, electromechanical mechanism or a portable device.

According to some embodiments, the transformable seat is configured to be transformed into a reclined or horizontal position.

According to some embodiments, the transformable seat is configured to transform its shape to provide a wide deceleration surface with which the user body is in contact upon impact to the monowheel.

According to some embodiments, the transformable seat is configured to be shifted in an opposite direction from an impact to the monowheel.

According to some embodiments, the transformable seat is configured to transform its shape to a rearward shifted semi-reclined position upon frontal impact to the monowheel.

According to some embodiments, the transformable seat configured to transform its shape to an upside-down position upon frontal impact to the monowheel.

According to some embodiments, the transformable seat is configured to transform its shape or bearings to provide a convenient enter/exit approach to a user.

According to some embodiments, the transformable seat is an ejection seat configured to be propelled out of the monowheel in case of an impending or actual severe impact.

According to some embodiments, the transformable seat is configured to be displaced vertically within the inner cavity of the monowheel to protect the user from impending or actual impact to the monowheel.

According to another aspect, there is provided a monowheel system comprising at least one transformable seat configured to be mounted within the inner cavity of the monowheel, a controller, a felloe and at least one spoke configured to be adaptively connected to the felloe

According to some embodiments, the configuration of the connection between the at least one spoke and felloe affects the stiffness level of the felloe.

According to some embodiments, a controller is configured to control the configuration of the connection of the at least one spoke felloe.

According to some embodiments, the stiffness of the felloe configured to increase upon impact in order to provide enhanced hardness level of the monowheel’s felloe.

According to some embodiments, the stiffness of the felloe configured to decrease upon impact in order to provide enhanced resilience level of the monowheel’s felloe.

According to some embodiments, the stiffness of the felloe configured to adapt in accordance to changing road conditions.

According to some embodiments, the transformable seat is an ejection seat configured to be propelled out of the monowheel in case of a severe impact.

According to another aspect, there is provided a monowheels formation, comprising at least two monowheels configured to be coupled by coupling means.

According to some embodiments, the at least two monowheels are configured to be coupled in a row.

According to some embodiments, the at least two monowheels are configured to be coupled in parallel.

According to some embodiments, at least one monowheel control the motion of at least one following monowheel.

According to some embodiments, at least one following monowheel is in an autonomous mode.

According to some embodiments, the formation of monowheels is configured to share power resources.

According to some embodiments, the felloes of the at least two coupled monowheels are spinning in opposite directions, and wherein said opposite spinning induces an electro-magnetic induction that generates an electrical current.

According to some embodiments, the generated electrical current is used to propel at least one monowheel of the monowheel formation.

According to some embodiments, the generated electrical current is stored within a designated battery.

According to another aspect, there is provided a method for using a transformable seat system, comprising the steps of using a controller to determine a preferred configuration or relative position of the adjustable parts forming the transformable seat or the bearings of the transformable seat and adjusting the configuration or relative position of the adjustable parts forming the transformable seat or the bearings of the transformable seat in accordance with the preferred determination.

According to some embodiments, the preferred determination is determined upon an impending or actual impact to the monowheel.

According to another aspect, there is provided a method for using a monowheel system, comprising the steps of using a controller to determine a preferred stiffness level of the felloe and adaptively adjusting the configuration of the at least one spoke and felloe in order to affect the stiffness level of the felloe.

According to some embodiments, the preferred stiffness level is determined upon an impending or actual impact to the monowheel.

According to another aspect, there is provided method for generating an electrical current, comprising the steps of providing a conductor located between at least two felloes and using the movement of the at least two felloes spinning in opposite directions relative to the conductor to induce an electro-magnetic current.

According to another aspect, there is provided method for creating a monowheel formation, comprising the steps of providing at least two monowheels configured to be coupled by coupling means and use said coupling means in order to create a formation of the at least two monowheels capable of simultaneous movement.

### BRIEF DESCRIPTION OF THE FIGURES

Some embodiments of the invention are described herein with reference to the accompanying figures. The description, together with the figures, makes apparent to a person having ordinary skill in the art how some embodiments may be practiced. The figures are for the purpose of illustrative description and no attempt is made to show structural details of an embodiment in more detail than is necessary for a fundamental understanding of the invention. For the sake of clarity, some objects depicted in the figures are not to scale.

In the Figures:

FIGS. 1A-1C constitute a schematic perspective view of a transformable seat installed within a monowheel system, according to some embodiments.

FIGS. 2A-2C constitute a schematic perspective view of a transformable seat installed within a monowheel system, according to some embodiments.

FIGS. 3A-3C constitute a schematic perspective view of a transformable seat installed within a monowheel system, according to some embodiments,

FIGS. 4A-4B constitute a schematic perspective view of a transformable seat installed within a monowheel system, according to some embodiments.

FIGS. 5A-5B constitute a schematic perspective view of a transformable seat installed within a monowheel system, according to some embodiments.

FIGS. 6A-6B constitute a schematic perspective view of a felloe and supporting spokes installed within a monowheel system, according to some embodiments.

FIGS. 7A-7B constitute a schematic perspective view of a plurality of coupled monowheels, according to some embodiments.

FIG. 8 constitutes a schematic perspective view of coupled monowheels, according to some embodiments.

### DETAILED DESCRIPTION OF SOME EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, “setting”, “receiving”, or the like, may refer to operation(s) and/or process(es) of a controller, a computer, a computing platform, a computing system, or other electronic computing device, that manipulates and/or transforms data represented as physical (e.g., electronic) quantities within the computer’s registers and/or memories into other data similarly represented as physical quantities within the computer’s registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently.

The term “Controller”, as used herein, refers to any type of computing platform that may be provisioned with a memory device, a Central Processing Unit (CPU) or microprocessor device, and several input/output (I/O) ports, such as, for example, a general-purpose computer such as a personal, laptop or a tablet computer, single-board computer (SBC) or a cloud computing system. Such controller may include, operate, use, employ, implement or otherwise engage artificial intelligence capabilities, such as a deep-learning system that can be, for example, conventional neural network (or CNN) configured to optimize the tasks to be controlled. The term “Controller”, as used herein, may also refer to a mechanical control system such as a gyroscope adapted to provide a mechanical or electrical output as a result of crossing a predefined threshold, hydraulic apparatus and other mechanically based controlling means.

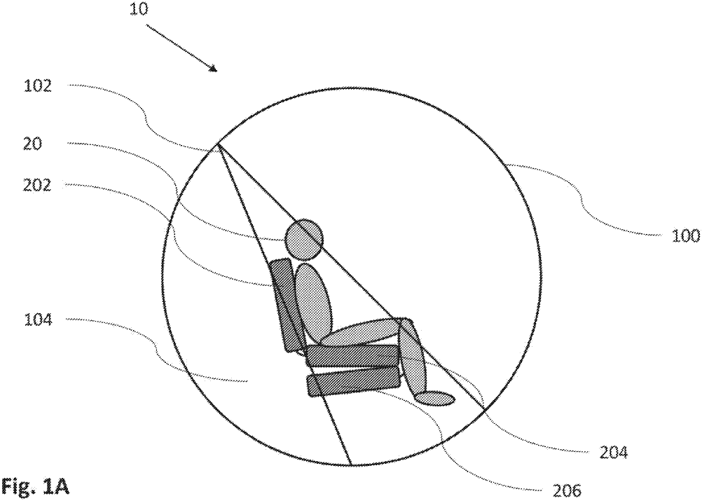

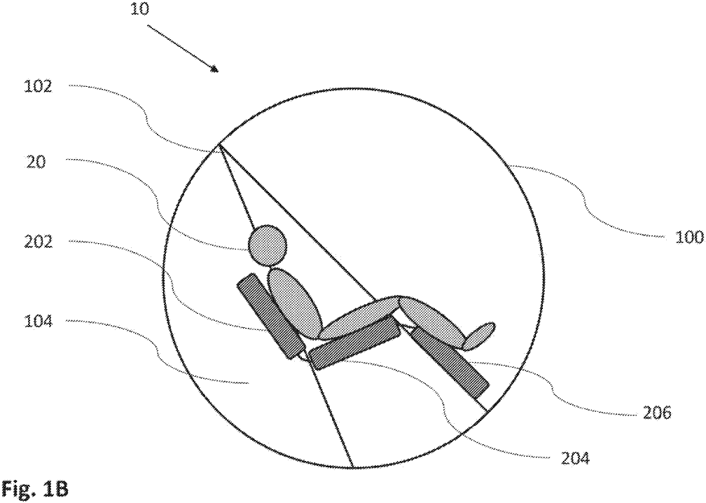

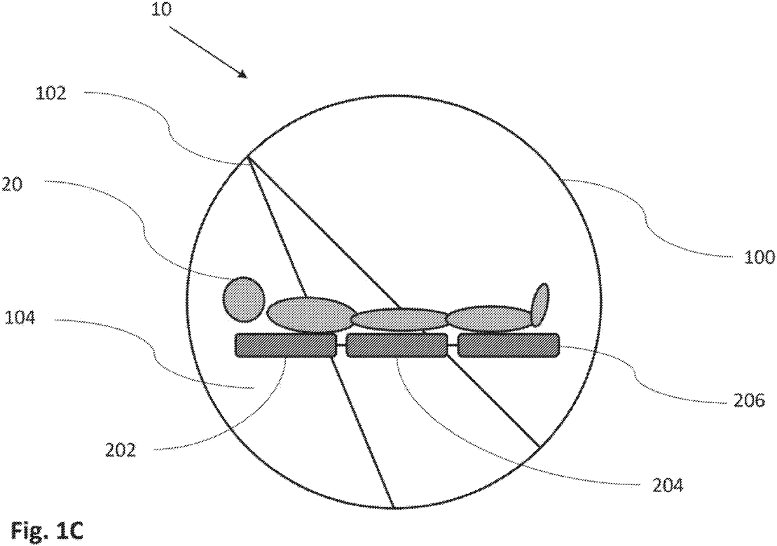

Reference is made to FIGS. 1A, 1B and 1C which constitute a schematic perspective view of a transformable seat 104 installed within vehicle 10, according to some embodiments of the invention. As shown, vehicle 10 may be a monowheel comprising a felloe 100 configured to rotate during the movement of vehicle 10 while user 20 is seated therein, and at least one spoke 102 configured to connect to said felloe 100. According to some embodiments, transformable seat 104 is placed and mounted inside the inner space formed within fellow 100 and supported by fastening means (not shown).

According to some embodiments, said fastening means may comprise one or more hinges such as rotational hinges, ball and socket hinges, swivels, cogwheels etc. According to some embodiments, said fastening means may comprise resilient connectors such as springs or hydraulic cylinders, electrical/mechanical motors, suspension rods etc. According to some embodiments, said fastening means may comprise rails, for example, slide rails which allow, each or in combination, a position change of transformable seat 104 relative to spoke 102 or relative to felloe 100.

According to some embodiments a controller (not shown), may be integrated within vehicle 10 or may be a separated device configure to control the shape and bearings of transformable seat 104. According to some embodiments, said controller may be a portable device or a part of a portable device carried by user 20, for example, a mobile cellular device, laptop, tablet etc. According to some embodiments, the controller may be a mechanical gyroscope, a gyroscope sensor, an accelerometer sensor, an image sensor, a light (such as laser) sensor or a mechanical (impact) sensor or any other device configured to detect changes in motion and/or orientation of a monowheel.

According to some embodiments, transformable seat 104 comprises a back-rest 202 and a bench 204 that may be inter-connected by coupling means such as hinges, axes, cylinders, electrical/mechanical motors, cogwheels, rails, swivels, etc. According to some embodiments, said coupling means may be operable either by mechanical, magnetic, electrical, hydraulic mechanisms and apparatus, etc. and be configured to change their bearings or orientation. According to some embodiments, said fastening means, as well as said coupling means between parts forming the transformable seat 104, enable it to transform its shape and/or bearings. According to some embodiments such transformations may be facilitated by servo mechanisms.

According to some embodiments, leg extension part 206 may be inter-connected to the bench 204 of transformable seat 104 by the same coupling means and control mechanisms previously disclosed.

According to some embodiments, an adjustment of said coupling means, as well as an adjustment of said fastening means that mounts seat 104 to vehicle 10 may be conducted as a result of changing conditions or as a result of an operation performed by user 20. According to some embodiments, said changing condition may be a collision or an impact absorbed by vehicle 10 that may trigger an output response from the controller, or an impending impact sensed by the controller. For example, an impending impact, an imminent collision or loss of control over vehicle 10 (e.g. rollover). According to some embodiments, an adjustment of said fastening or coupling means may be conducted as a result of user 20 choosing to change the transformable seat 104′s shape and/or bearings in accordance to his preferences and/or in view of certain changes in vehicle 10 orientation.

According to some embodiments, when in regular position, transformable seat 104 provides an erect or semi-erect position enabling a convenient driving/travelling posture as shown in FIG. 1A. According to some embodiments, as a result of user 20 choosing to change the transformable seat 104′s shape and/or bearings, transformable seat 104 may transform its bearings to a reclined position as shown in FIG. 1B. According to some embodiments, said reclined position may allow user 20 to rest or sleep while vehicle 10 is stopped or carried by another vehicle (such as a train, ferry, truck etc.), while vehicle 10 is in an autonomous travel mode, or while vehicle 10 being remotely controlled by another, adjacent, vehicle 10 as further disclosed hereinafter.

According to some embodiments, transformable seat 104 may transform its bearings and shape to a horizontal position as shown in FFIG. IC. According to some embodiments, said horizontal, bed like position, may allow user 20 to rest or sleep while vehicle 10 is stopped, carried by another vehicle (such as a train, ferry, truck etc.), while vehicle 10 is in an autonomous travel mode. or while vehicle 10 being remotely controlled or controlled by another, adjacent, vehicle 10 as further disclosed hereinafter.

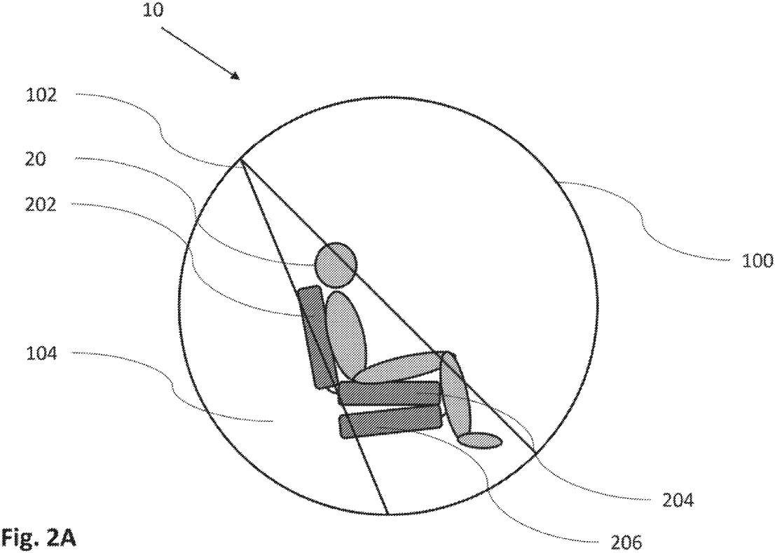

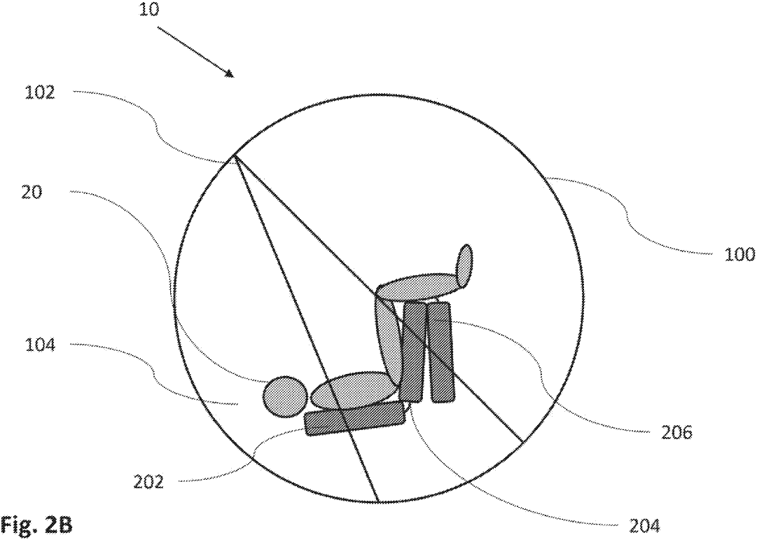

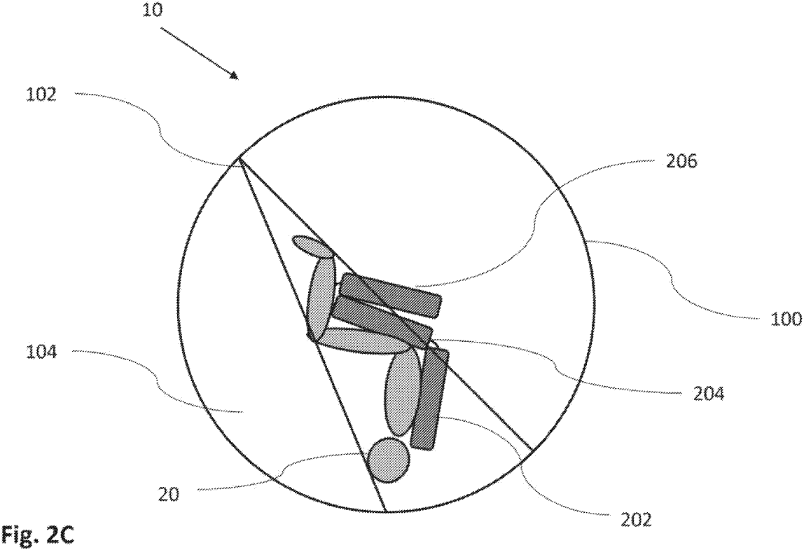

Reference is made to FIGS. 2A, 2B and 2C which constitute a schematic perspective view of a transformable seat 104 mounted within vehicle 10, according to some embodiments of the invention. As shown, when in regular position, transformable seat 104 provides an erect or semi-erect position enabling a convenient driving posture as shown in FIG. 2A. According to some embodiments, transformable seat 104 may transform its position to a rearward-shifted semi-reclined position or, alternatively, to an upside-down position shown in FIG. 2B. and 2C respectively.

According to some embodiments, said rearward-shifted semi-reclined position of transformable seat 104 may protect the user in a case of a frontal collision/impact caused to vehicle 10. For example, in case of a frontal collision, meaning, wherein vehicle 10 absorbs an impact at a section facing its direction of movement, transformable seat 104 may change its position to a rearward-shifted semi-reclined position such that user 20 may substantially face the upper section of vehicle 10. According to some embodiments, in a case of an impending or actual frontal collision or impact, said rearward-shifted semi-reclined position may provide a maximized contact platform area between user 20′s body and bench part 204 since in said position, and during a frontal collision/impact, bench 204 stops the advancement of user 20′s body, hence providing a relatively wide area that absorbs the deceleration force caused by said impact. According to some embodiments, active acceleration of a user in a direction opposite to the direction of vehicle 10 movement, caused by movement of transformable seat 104, may be used to reduce the net deceleration experienced by the user’s body in case of a collision.

According to some embodiments, said rearward-shifted semi-reclined position of transformable seat 104 may also prevent or diminish a whiplash injury that may be caused by a sudden movement of the user’s 20 head. According to some embodiments, said rearward-shifted semi-reclined position may be achieved by either forward or rearward rotation of transformable seat 104.

According to some embodiments, the upside-down position depicted in FIG. 2C may also provide an alternative protective configuration to user 20 in a case of a frontal collision/impact caused to vehicle 10. For example, in case of a frontal collision, meaning, wherein vehicle 10 absorbs an impact at a section facing its direction of movement, transformable seat 104 may change its position to an upside-down position such that user 20 may face the rear section of vehicle 10. According to some embodiments, said upside-down position of transformable seat 104 may stop the advancement of user 20′s body and maximize the contact of user 20′s body with back-rest part 202, hence, providing a relatively wide area that absorbs the deceleration force caused by said impact.

According to some embodiments, said upside-down position of transformable seat 104 may also prevent or diminish a whiplash injury that may be caused by a sudden movement of the user’s 20 head. According to some embodiments, said upside-down position may be achieved by either forward or rearward rotation of transformable seat 104.

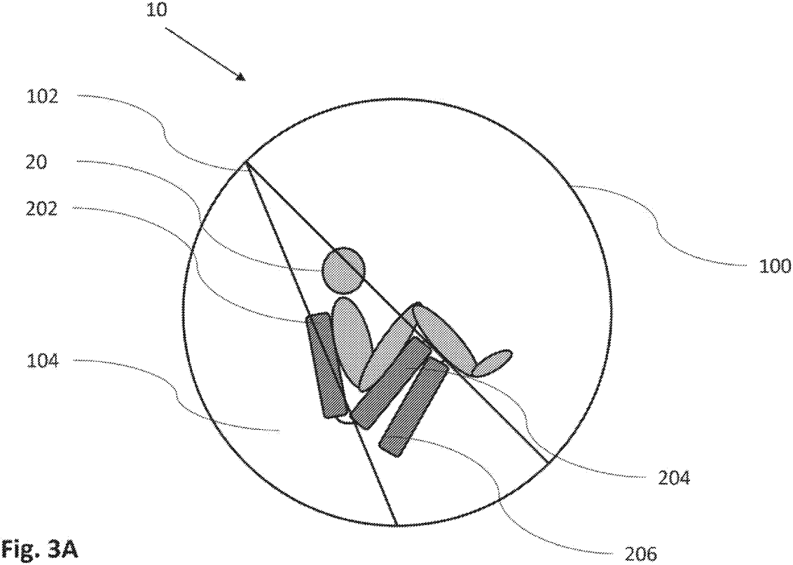

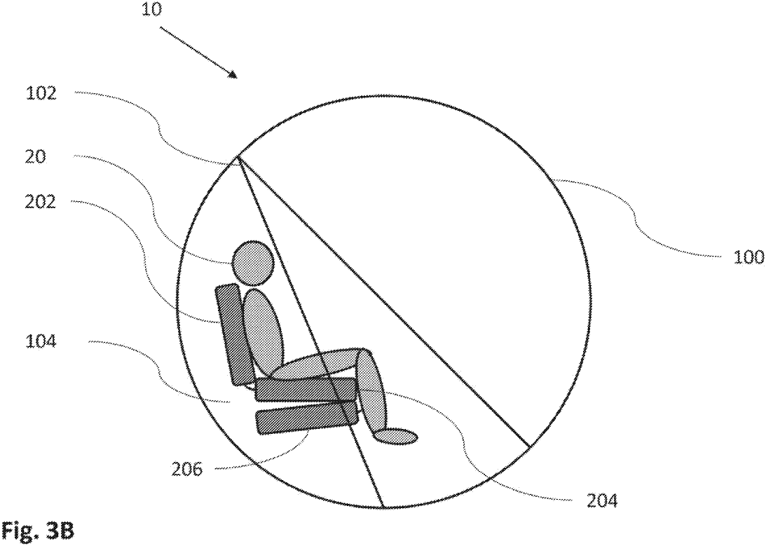

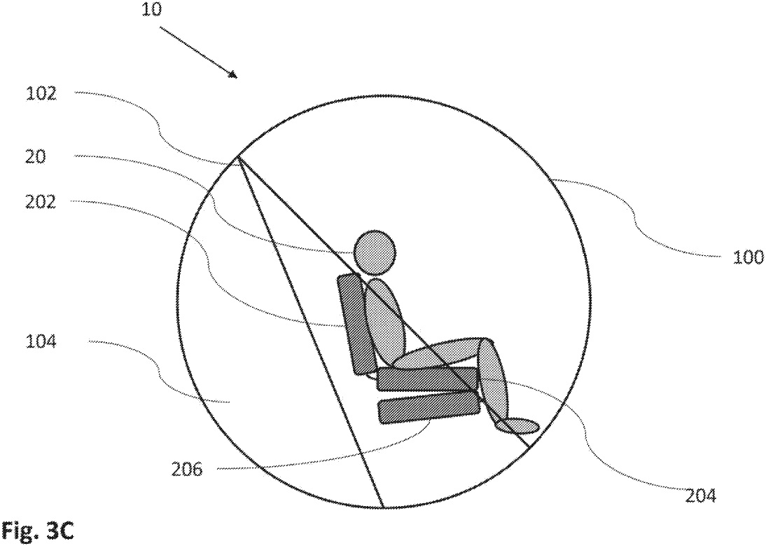

According to some embodiments, transformable seat 104 may change its configuration/bearings to provide a relatively wide area that absorbs the deceleration force caused by an impact/collision occurring anywhere across vehicle 10. For example, a rear, side, upper or bottom impacts may cause transformable seat 104 to change its configuration/bearings accordingly in order to provide a wide decelerating platform for user 20′s body. Reference is made to FIGS. 3A, 3B and 3C which constitute a schematic perspective view of a transformable seat 104 installed within vehicle 10, according to some embodiments of the invention. As shown, in case of an impact or collision, the bench part 204 or, alternatively, any other part of transformable seat 104 may retract in order to protect user 20′s lower limbs, as shown in FIG. 3A. According to some embodiments, said retraction of parts comprising transformable seat 104 may distance users 20′s limbs from the perimeter of vehicle 10, hence reduce the possibility that user 20′s limbs or other body parts will hit a hard surface or be injured by a collapsing section of vehicle 10. According to some embodiments, said retraction may also serve in protecting the internal organs of user 20 upon impact.

According to some embodiments, transformable seat 104 may be shifted forward/backward along a horizontal line A crossing the inner space surrounded by felloe 100. For example, in case of a frontal collision, meaning, wherein vehicle 10 absorbs an impact at a section facing its direction of movement, transformable seat 104 may be shifted to the opposite direction in order to distance user 20 from the impact zone, hence reducing the possibility that user 20′s limbs or other body parts will hit a hard surface or be injured by a collapsing section of vehicle 10, and reducing the net maximal deceleration rate experienced by user 20′s body, as shown in FIG. 3B.

According to some embodiments, in case of a posterior impact or rear collision, meaning, wherein vehicle 10 absorbs an impact at a section contrary to its direction of movement, transformable seat 104 may be shifted to the opposite direction in order to distance user 20 from the impact zone, hence reducing the possibility that user 20′s limbs or other body parts will hit a hard surface or be injured by a collapsing section of vehicle 10 as shown in FIG. 3C.

According to some embodiments, seat 104 may be shifted, displaced or rolled over along the vertical, horizontal or lateral axes of vehicle 104 so as to distance user 20 from an impending impact to vehicle 10, hence reducing the possibility that user 20′s limbs or other body parts will hit a hard surface or be injured by a collapsing section of vehicle 10.

According to some embodiments, vehicle 10 is has a configuration that allows for comprehensive positioning of seat 104 within the inner cavity of vehicle 10. For example, vehicle 10 is a monowheel that, in comparison to traditional vehicles, has a sphere-like shape which allow seat 104 to be shifted vertically, horizontally or laterally, whereas a conventional vehicle is elongated and narrow which restrict its available inner space. Moreover, a typical monowheel has no additional seat behind user 20 seat and generally no conventional steering wheel, hence there is more inner space for various positioning of seat 104 in accordance to changing need and circumstances.

According to some embodiments, vehicle 10 may comprise a counter propulsion mechanism configured to be activated in case of impending or actual impact identified by the controller. For example, the controller may identify a collision/impact about to happen, and then send a command to the motor to switch its direction of movement such that vehicle 10 will deaccelerate or, alternatively, start moving in a direction opposite from impending impact. According to some embodiments, this counter propulsion feature may reduce the kinetic energy of vehicle 10 and hence, may reduce possible damage that may be caused to vehicle 10 upon the impending collision as well possible injury that may be caused to user 20 seated within.

According to some embodiments, transformable seat 104 may change its bearings in order to enhance comfort, safety or performance level of seated user 20. For example, transformable seat 104 may change its bearings in accordance with vehicle 10′s direction of movement in order to prevent queasiness when travelling backwards and vice versa. In yet another example, transformable seat 104 may change its bearings in accordance with vehicle 10′s direction of movement in order to provide user 20 with a direct line of sight when vehicle 10 is advancing uphill, downhill or turning.

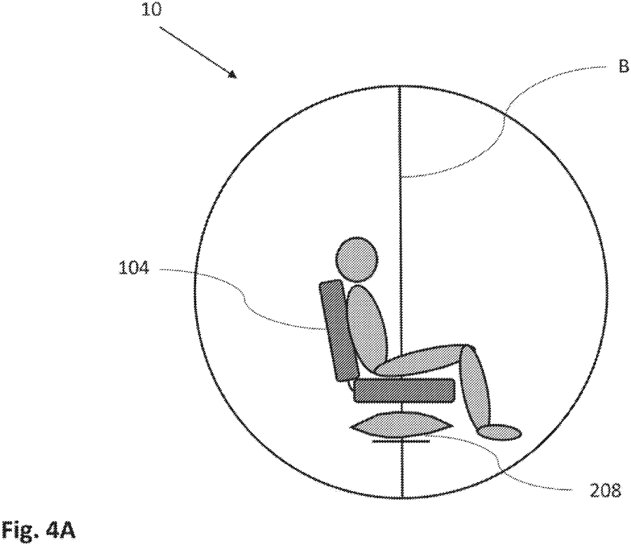

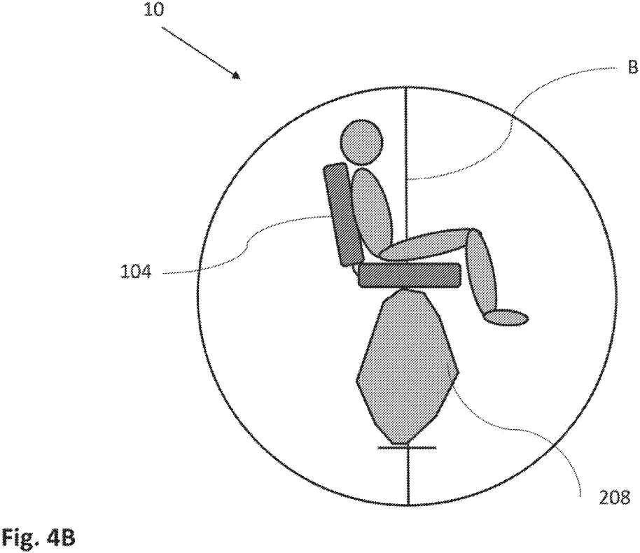

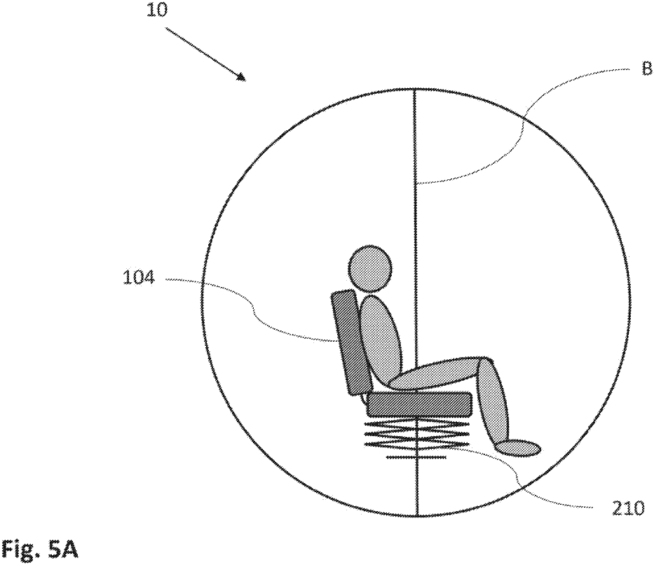

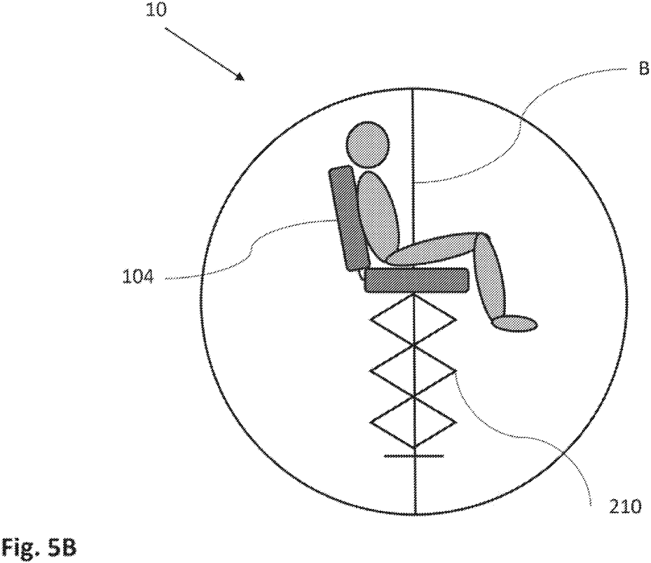

Reference is made to FIGS. 4A to 5B which constitute a schematic perspective view of a transformable seat 104 installed within vehicle 10, according to some embodiments of the invention. As shown, transformable seat 104 may be shifted along a vertical line B in order to protect user 20 in case of a collision or impact. According to some embodiments, transformable seat 104 may be displaced using a resilient or buoyant device, mechanical gears, hydraulic system, etc. For example, a buoyant device such as an airbag 208 may be inflated upon an impact/collision detected by the controller, in order to push transformable seat 104 upward. According to some embodiments, said upward movement of transformable seat 104 may distance user 20 from the lower part of vehicle 10 and reduce the possibility that user 20′s limbs or other body parts will hit a hard surface or be injured by a collapsing section of vehicle 10 caused by a lower impact/collision to vehicle 10. According to some embodiments, said resilient or buoyant device may be a springs system 210 that, upon an impact/collision, detected by the controller, may push transformable seat 104 upward for the same purpose disclosed above.

According to some embodiments, the controller enables to predict future collisions and as a consequence, enable to adjust the seat movement/adjustments prior to the actual collision. Hence, injuries or over-stressing the human body with unbearable accelerations may be prevented.

According to some embodiments, the structure of vehicle 10 may comprise buoyancy and/or resilience properties which enable it to absorb the energy of an impact or a collision. According to some embodiments, said buoyancy and/or resilience properties may be adjusted using a structural component designed to increase/decrees the structural stiffness of vehicle 10 as disclosed hereinafter.

According to some embodiments, transformable seat 104 may be shifted in any direction within vehicle 10 using a resilient or buoyant device, mechanical gears, hydraulic system, etc. in order to distance user 20 from an impact zone and reduce the possibility that user 20′s limbs or other body parts will hit a hard surface or be injured by a collapsing section of vehicle 10 caused by an impact/collision occurring anywhere across vehicle 10.

According to some embodiments, transformable seat 104 may provide an improved accessibility by adapting its position to user 20 entering to or exiting from vehicle 10. For example, transformable seat 104 may lean or recline toward user 20 and retract to a convenient driving position after user 20 has taken a sit. Transformable seat 104 may also be shifted forward/backward along a horizontal line A or up/down along vertical line B in order to provide easy accessibility to user 20.

According to some embodiments, transformable seat 104 may adapt its position to provide a compensated position with regard to the vehicle 10 general position. For example, if vehicle 10 rests or moves along a steep slope, transformable seat 104 may rotate or change its bearings in order to compensate for the inclined position and provide a relatively horizontal seat for user 20 while driving, entering or evacuating vehicle 10.

According to some embodiments, transformable seat 104 may change its bearings in order to improve the line of sight of user 20 seated within. For example, when vehicle 10 is moving up/down a steep slope, transformable seat 104 may change its bearings such that user 20 may face the direction of movement and may better see the road ahead.

According to some embodiments, transformable seat 104 may keep a certain position regardless of the general bearings of vehicle 10. For example, transformable seat 104 may stay in an erect of semi-erect or any other driving position even when vehicle 10 is on the move while constantly changing its bearings. According to some embodiments, said position adaptations of transformable seat 104 are controlled by the controller.

According to some embodiments, a suspension mechanism may be installed on transformable seat 104 so as to passively or actively absorb shocks during the movement of vehicle 10 and thus increasing user 20′s comfort level.

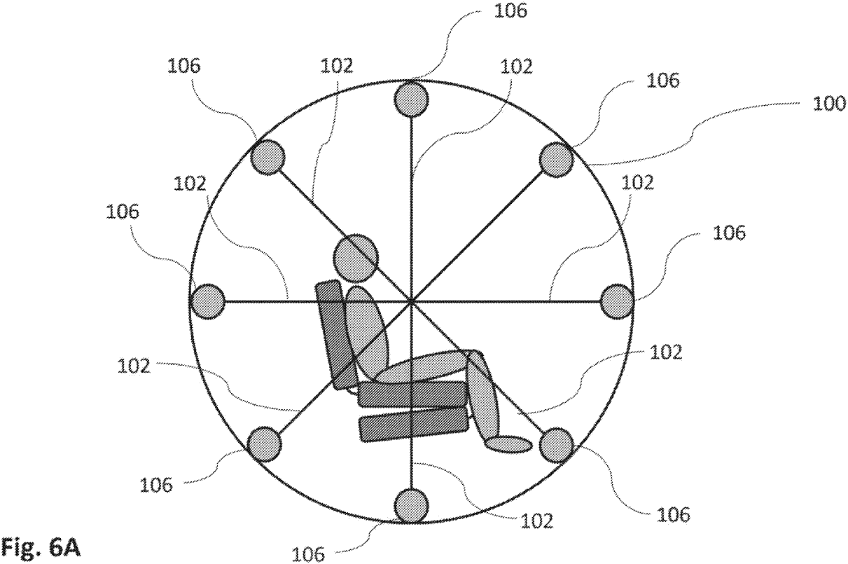

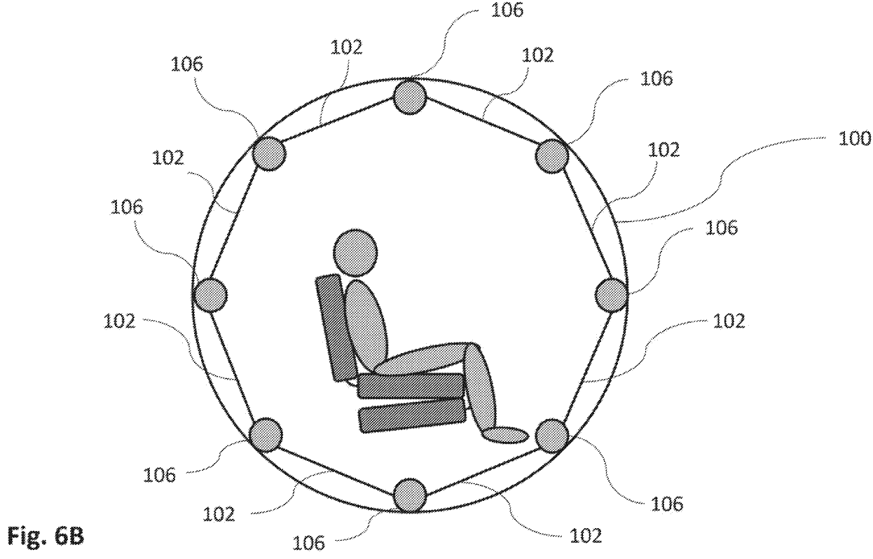

Reference is made to FIGS. 6A, 6B which constitute a schematic perspective view of a felloe 100 and supporting spokes 102 of a vehicle 10, according to some embodiments of the invention. As shown, vehicle 10 may be a monowheel comprises a felloe 100 configured to change its flexibility level. This may be achieved by providing a joint 106 between the felloe 100 and the at least one spoke 102. According to some embodiments, said joint 106 may be a hinge, a resilient member, gears system, hydraulic system or any other kind of connector allowing spoke 102 to be adjustably connected to felloe 100. According to some embodiments, multiple spokes 102 may be connected to felloe 100 through multiple joints 106 such that at any given moment, at least one spoke 102 is connected to a section of felloe 100 that is currently in contact with the ground.

According to some embodiments, the controller may be configured to adjust the felloe 100 flexibility level in accordance with changing needs by controlling the angle of spokes 102 in relation to the felloe 100 or, alternatively, by controlling the length of spokes 102 or joints 106. The controller may adjust the stiffness/flexibility level of felloe 100 in accordance with changing conditions, for example, when a need to absorb shocks arises while driving upon a faulty road, when a need to provide an increased grip arises during high-speed driving intervals, when it is preferable to provide an increased comfort level to user 20 while driving vehicle 10, etc.

According to some embodiments, the stiffness/flexibility level of at least a part of felloe 100 may be amended and manipulated by using an electric device that may control the mechanical properties (such as elasticity, buoyancy) of felloe 100.

According to some embodiments, said adaptable flexibility of felloe 100 can also improve the safety of vehicle 10. For example, upon an upcoming impact or while an impact occurs, at least a portion of felloe 100 may become stiffer in order to resist said impact or, alternatively, at least a portion of felloe 100 may become flexier in order to absorb said impact’s energy, hence reducing its damaging effects.

According to some embodiments, said adaptable flexibility of felloe 100 may also be achieved through realignment of one or more spokes 102, through change in the compliance or resistance of one or more joints 106, or through electrical-induced alteration in the mechanical properties of felloe 100 or a portion thereof.

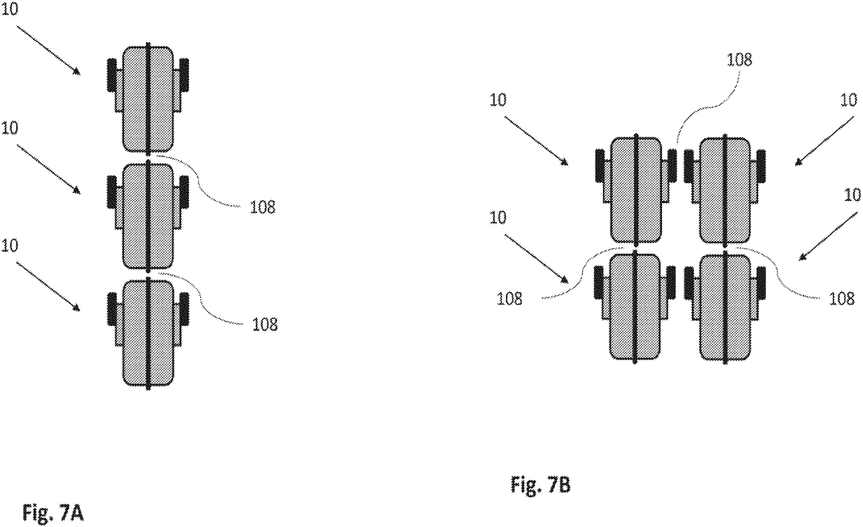

Reference is made to FIGS. 7A, 7B which constitute a schematic perspective view of a plurality of vehicles 10 coupled in tandem, according to some embodiments of the invention. As shown, vehicle 10 may be a monowheel configured to connect to at least one additional vehicle 10 using coupling means 108. According to some embodiments, coupling means 108 may be any kind of fasteners such as, hinges, joints magnetic/electromagnetic connectors, hook-loop connectors, etc. According to some embodiments, the coupling of vehicles 10 using coupling means 108 may allow a certain degree of freedom of movement between coupled vehicles 10. According to some embodiments, said coupling means 108 may include, one or more swivels, hinges, anchors, bands, cables, magnets, electromagnets etc.

According to some embodiments, coupled vehicles 10 may be connected in a row as depicted in FIG. 7A, using coupling means 108. According to some embodiments, such convoy of coupled vehicles 10 is able to turn by following a turn made by the first vehicle 10. According to some embodiments, additional coupled vehicles 10 may follow the first vehicle 10 while being in an autonomous mode that does not require the attention of user 20 seated within. According to some embodiments, said convoy of coupled vehicles 10 is able to simultaneously turn, wherein said turn is made by all vehicles forming the convoy.

According to some embodiments, coupling of two or more vehicles 10 reduces energy demands while also providing stability during a turn, acceleration or breaking. According to some embodiments, longitudinal coupling of two or more vehicles 10 reduces energy consumption by improving air flow characteristics and therefore reducing the drag coefficient of said coupled vehicles 10.

According to some embodiments, a designated operational module such as a controller is configured to control said convoy of coupled vehicles 10 wherein said controller may control the acceleration, deceleration, roll and turning, breaking etc. According to some embodiments, several controllers may be functionally coupled using wired or wireless connection in order to enable control of said convoy of coupled vehicles 10 in response to user 20 operations/commands. The breaking/accelerating and general maneuverability of said convoy of coupled vehicles 10 may be improved by reducing rollover susceptibility.

According to some embodiments, at least two vehicles 10 may be coupled to each other in a parallel manner using coupling means 108, hence forming a cluster of vehicles 10 that are substantially attached side-by-side. According to some embodiments, said cluster of coupled vehicles 10 is able to turn following a turn of the first vehicles 10 leading the cluster, as described above. According to some embodiments, said cluster of coupled vehicles 10 is simultaneously maneuverable, for example, wherein a turn of all vehicles forming the cluster is conducted at the same time. The breaking/accelerating and general maneuverability of said cluster of coupled vehicles 10 may be improved by reducing rollover susceptibility.

According to some embodiments, a plurality of coupled vehicles 10 may be control led by one or more coupled vehicle/s 10 while being in an autonomous mode. Such control may be obtained by a controller and conducted using connection means (not shown) that can be, for example, a wired or wireless connection configured to enable one vehicle 10 to communicate with other connected vehicles 10 so that all connected vehicles 10 are able to move and maneuver in concert.

According to some embodiments, the energy needed to power the plurality of connected vehicles 10 may be shared among the participating vehicles 10. For example, one vehicle 10 may operate as an energy source for other vehicle(s) 10 by providing an electrical current to another adjacent vehicle(s) 10. According to some embodiments, this may be obtained by an electric connection between vehicle(s) 10 or by means of electric charging of a battery associated with said another vehicle(s) 10. According to some embodiments, a power network may be formed by a plurality of connected vehicles 10 using a common reservoir of power.

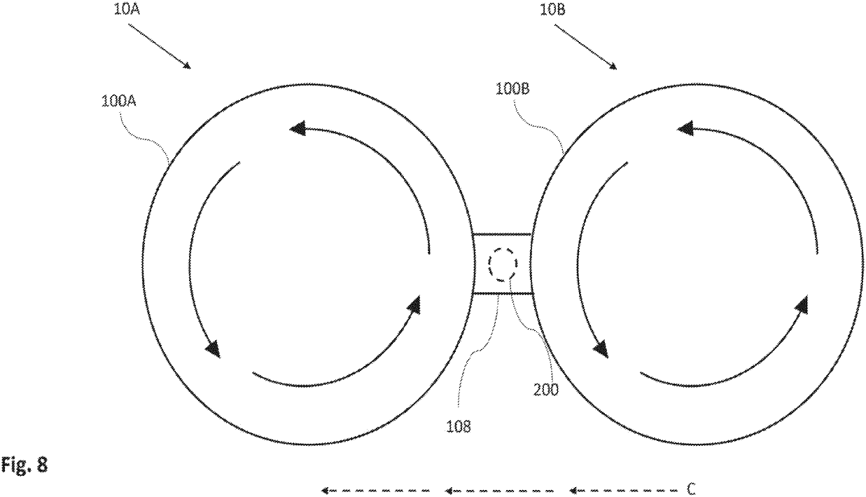

Reference is made to FIG. 8 which constitutes a schematic perspective view of coupled vehicles 10, according to some embodiments of the invention. As shown, at least two adjacent vehicles 10A and 10B are coupled using coupling means 108 and configured to be advanced in direction C. Felloe 100A is associated with vehicle 10A and felloe 100B is associated with vehicle 10B, wherein both felloes are configured to spin in opposite directions relative to a reference point 200 while advancing along a path in said direction C. According to some embodiments, an electro-magnetic induction caused by the opposite spinning of metal alloys which may form felloes 100A and 100A may generate an electrical current that may be used for the operation of vehicle/s 10A and 10B. According to some embodiments, said electro-magnetic current may be exploited to directly propel vehicle/s 10A or 10B or, alternatively, may be exploited to propel other vehicles 10 belonging to a coupled formation of vehicles 10. According to some embodiments, an electrical conductor means may be installed at reference point 200.

According to some embodiments, the electrical current formed by the electro-magnetic induction may be stored in a battery associated with a vehicle 10 or in a common reservoir of batteries associated with a coupled formation of vehicles 10 and can be used for a future propulsion of either one of vehicles 10 or of the coupled formation of vehicles 10 generating the electro-magnetic induction.

According to some embodiments, vehicle 10 may comprise a system designed to evacuate user 20 from vehicle 10. Said system may be an ejection seat (not shown) configured to eject user 20 from vehicle 10 in case of a collision, impact, fire, etc. According to some embodiments, said ejection seat may be configured to propel user 20 out of vehicle 10 such that user 20 using a propulsion mechanism. According to some embodiments, a controller is configured to sense a predicted severity of an upcoming impact and determine whether or not to activate the ejection seat.

According to some embodiments, the ejection seat may be activated only if a certain threshold is achieved. For example, the controller may calculate various parameters regarding an upcoming impact, collision, fire etc. and determine which safety measure needed to be activated, and activate the ejection seat only as a last resort. According to some embodiments, vehicle 10 is a monowheel which inherently includes a safety belt as part of its seat. This arrangement enables the operation of an ejection seat and seat position transformation as part of vehicle 10. That is in contrast to a motorcycle, Segway, scooter etc. which do not include a safety belt and hence cannot include an ejection seat.

Although the present invention has been described with reference to specific embodiments, this description is not meant to be construed in a limited sense. Various modifications of the disclosed embodiments, as well as alternative embodiments of the invention will become apparent to persons skilled in the art upon the reference to the description of the invention. It is, therefore, contemplated that the appended claims will cover such modifications that fall within the scope of the invention.

1-49. (canceled)

50. A transformable seat system for use in a monowheel, the system comprising:
(i) at least one transformable seat comprises at least two adjustable parts and configured to be mounted within the inner cavity of the monowheel; and
(ii) a controller,
wherein the controller is configured to control the configuration or relative position of the adjustable parts forming the transformable seat or the bearings of the transformable seat.

51. The system of claim 50, wherein the transformable seat is configured to be transformed into a reclined position.

52. The system of claim 50, wherein the transformable seat is configured to be transformed into a horizontal position.

53. The system of claim 50, wherein the transformable seat is configured to transform its shape to provide a wide deceleration surface upon an impending or actual impact to the monowheel.

54. The system of claim 50, wherein the transformable seat is configured to be shifted in an opposite direction from an impending or actual external impact to the monowheel.

55. The system of claim 50, wherein the transformable seat is configured to transform its shape to a shifted semi-reclined position upon impending or actual external impact to the monowheel.

56. The system of claim 50, wherein the transformable seat is configured to transform its shape to an upside-down position upon impending or actual external impact to the monowheel.

57. The system of claim 50, wherein the transformable seat is configured to be displaced vertically within the monowheel so as to protect the user from upon impending or actual external impact to the monowheel.

58. The system of claim 50, wherein the transformable seat is configured to transform its shape or bearings to provide a convenient enter/exit approach to a user.

59. The system of claim 50, wherein the transformable seat is an ejection seat configured to be propelled out of the monowheel in case of an impending or actual severe impact.

60. A monowheel system, comprising:
(i) a felloe; and
(ii) at least one spoke configured to be adaptively connected to the felloe,
wherein the configuration of the connection between the at least one spoke and felloe affects the stiffness level of the felloe.

61. The system of claim 60, wherein a controller is configured to control the configuration of the connection of the at least one spoke to the felloe.

62. The system of claim 60, wherein the stiffness level of the felloe is configured to increase upon an impending or actual impact in order to provide enhanced hardness level of the monowheel’s felloe.

63. The system of claim 60, wherein the stiffness level of the felloe is configured to decrease upon an impending or actual impact in order to provide enhanced resilience level of the monowheel’s felloe.

64. The system of claim 60, wherein the stiffness level of the felloe is configured to adapt in accordance with changing road conditions.

65. The system of claim 60, comprising at least one transformable seat configured to be mounted within the inner cavity of the monowheel.

66. The system of claim 65, wherein the transformable seat is an ejection seat configured to be propelled out of the monowheel in case of an impending or actual severe impact.

67. The system of claim 65, wherein the transformable seat is configured to be displaced vertically within the monowheel in order to protect the user from impending or actual impact to the monowheel.

68. A method for creating a monowheels formation, comprising the steps of:
(i) providing at least two monowheels configured to be coupled by coupling means.
(ii) use said coupling means in order to create a formation of at least two monowheels capable of simultaneous movement.

69. The method of claim 68 capable of generating an electrical current using a formation of monowheels and comprising the steps of:
(i) providing at least two electrically conducive felloes that spin in opposite directions relative to a reference point; and
(ii) using the movement of the at least said two felloes to induce electro-magnetic fields at said reference point.
